(19) United States
(12) Patent Application Publication
(10) Pub. No.: US 2015/0342324 A1
(43) Pub. Date: Dec. 3, 2015

(54) DEVICE ATTACHING MECHANISM

(71) Applicant: Brian Zhao, Daly City, CA (US)

(72) Inventor: Brian Zhao, Daly City, CA (US)

(21) Appl. No.: 14/723,234

(22) Filed: May 27, 2015

Related U.S. Application Data
(60) Provisional application No. 62/003,031, filed on May 27, 2014.

(51) Int. Cl. A45F 3/02; F16M 13/02; F16M 13/06

(52) U.S. Cl. CPC A45F 3/02; F16M 13/06; F16M 13/02

(57) ABSTRACT

A mechanism for conveniently attaching a mobile, portable or handheld device to a user. The mechanism includes a retractable line implement for attaching the mobile device to an object, a user, a monitored or tracked subject. The mechanism also includes a reel device for holding the line implement when not in use, a reel winding mechanism for manually or automatically retracting the line implement, a clip mechanism for adjusting a length of the line implement and hold the line implement to a preferred length, and a tension point segment that breaks apart when excessive force is applied to the mechanism to prevent injury to a user.

### CROSS-REFERENCE TO RELATED APPLICATIONS

The present Utility patent application claims priority benefit of the [U.S. provisional application for patent Ser. No. 62/003,031 entitled “MOBILE DEVICE CHEST ATTACHMENT SYSTEMS AND METHODS”, filed on 2014 May 27, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to accessories for mobile, portable, or handheld devices. More particularly, the invention relates to mechanisms that may be used for securing mobile, portable, or handheld devices to an individual.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is contemplated that some individuals may wish to attach various different types of mobile devices to their bodies such as, but not limited to, smart phones, body cameras, action cameras, heart monitors, GPS tracking devices, and other electronic devices, etc. These attached devices may be used for a multiplicity of suitable applications including, without limitation, recording sport or adventure activities, health monitoring, location monitoring, occupational activity documentation, etc.

By way of educational background, an aspect of the prior art generally useful to be aware of is that there are some available devices that may enable a user to attach a mobile device to their body. Many of these devices use straps or systems of straps, for example, without limitation, an arm strap carrier for a mobile device, strap holders that may be attachable to a mobile device or a mobile device case, a swivel connector system for a mobile device, a device that may be used to connect a flexible strap or lanyard to a handheld device, and wrist-based strap systems and methods to carry mobile device(s). When the straps are unused, it is believed that the user typically lets the straps hang loosely or wraps the straps around the mobile device, which may cause the straps to become unwieldy or may block access to functions of the mobile device.

By way of educational background, another aspect of the prior art generally useful to be aware of is that some approaches exist to enable some small accessories for mobile devices to be storable on the devices. For example, some such means may provide retractor reel assemblies on mobile device cases, in other attachable devices, or incorporated into the mobile devices for storing headphone cords, power cords, data cords, or cellular phone leashes. Such approaches may not handle larger accessories or other accessories that have different/other purposes.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic top view of an exemplary attachment mechanism, in accordance with an embodiment of the present invention; and

FIGS. 2A, 2B, 2C, 2D, 2E, 2F and 2G illustrate a user wearing an exemplary attachment mechanism, in accordance with an embodiment of the present invention. FIG. 2A is a diagrammatic front view of the mechanism in a dual line implementation with both set of line implement worn on the shoulder. FIG. 2B is a diagrammatic rear view with lines of the mechanism in an uncrossed configuration, and FIG. 2C is a diagrammatic rear view with the line implement of the mechanism in a crossed configuration. FIG. 2D is a diagrammatic front view of the mechanism in a single line implementation. FIG. 2E is a diagrammatic rear view the mechanism in a single line implementation. FIG. 2F is a diagrammatic front view of the mechanism in a dual line implementation with one set of the line implement on the shoulder and the other set under the armpit. FIG. 2G is a diagrammatic rear view the mechanism in the dual line implementation of FIG. 2F.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention relate to mechanisms for securing a mobile, portable or handheld device to a human chest for use during normal daily activity or sport activity. Some embodiments may comprise retractable strap systems that attach to or may be embedded into a mobile device to conveniently convert the mobile device into a body camera. These embodiments may provide attachment systems that are compact, lightweight, convenient to carry, easy to wear and handle, and safe to use. It is contemplated that various embodiments may be implemented for use with a multiplicity of suitable mobile, portable, or handheld devices such as, but not limited to, communication devices such as smart phones, cell phones, and android phones, body cameras, action cameras, health monitoring devices, GPS devices, heart rate monitors, wireless speakers, monitoring devices, tracking devices, other mobile, portable, or handheld electronic devices that may be developed in the future, etc. Furthermore, these devices may be worn by users for performing various different types of tasks including, without limitation, video recording, taking photographs, audio recording, health and fitness tracking, location tracking, entertainment, tracking or monitoring subjects, playing sports, leisure activities, meetings, etc.

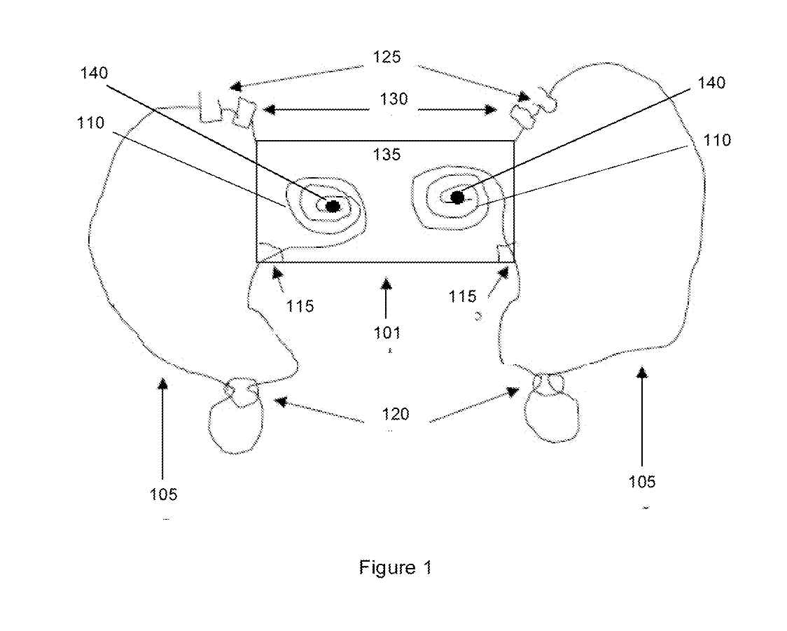

FIG. 1 is a diagrammatic top view of an exemplary attachment mechanism 101, in accordance with an embodiment of the present invention. In the present embodiment, attachment mechanism 101 comprises a case structure 100 and flexible, elastic or stretchable and retractable line implement 105 that may enable a user to mount a mobile device to a human chest or other body parts including, without limitation, an arm or leg. Line implement 105 may be retracted inside case 100 when not in use or for storage. In addition, some embodiments may be used to attach a mobile device or other devices to animals such as, but not limited to, pets or research animals or other objects such as, but not limited to, vehicles, bicycles, stationary objects, sports equipment, etc. It is contemplated that some embodiments may comprise only one retractable line or more than two retractable lines. In other embodiments, the case structure 100 may comprise the case of the mobile, portable or handheld device. By typically enabling lines 105 to be retractable in the present embodiment, attachment mechanism 101 may allow a user to conveniently bring the capability of converting a mobile device into a body camera virtually anywhere. Moreover, when lines 105 are in use, the lengths of lines 105 may be adjusted to fit bodies and body parts of different sizes by retracting lines 105 while a user is wearing attachment mechanism 101. Whether in use or not, any extra length of lines 105 may be stored away on reels 110, which may help prevent lines 105 from twisting or tangling with themselves, each other and/or other objects. In additional embodiments, the first and second line implements 105 may be retracted or loosened independently to conveniently allow a user the use of one or both lines 105, and to generally enable the mobile device to be comfortably and securely fixed to virtually any body part of the user or object, accommodate left-handed and/or right-handed individuals, and enable different attachment configurations. In other embodiments, first, second or both lines 105 may have multiple functions including, but not limited to, measuring tapes, decorative line items having a variety of colors, or both. Additionally, one or both lines may be non-elastic including leather straps, fabric straps, etc. Moreover, only a portion of lines 105 is elastic.

In the present embodiment, each retractable line implement 105 may be attached to a reel device 110 having an anchor point. When retracting lines 105, lines 105 rotate against one or more anchor points. Retractable lines 105 may be manually retracted on reels 110 or reels 110 may be spring-loaded so that lines 105 may be automatically retracted. A reel winding mechanism 140 comprises a foldable crank device which may be used to manually turn the reels 110 to retract lines 105. The crank device may then be folded after use to prevent injury to a user. On the other hand, reel winding mechanism 140 comprises a button which may be pressed down to start the automatic retraction, and/or the button may be pushed back to allow automatic protraction. Adequate or requisite tension may typically be needed on lines 105 to pull the device securely against the body or object to which the device is attached. In operation, when elastic lines 105 are pulled against the body or object, lines 105 experiences internal forces that oppose the deformation and restore lines 105 to their original state if the external pulling force is no longer applied. In addition to the force provided by elastic lines 105, if reels 110 are spring-loaded, the strength of the springs may also be used as a portion or the entirety of the tension securing the mobile device on the user. In the present embodiment, attachment mechanism 101 comprises clip mechanisms 115 that may hold flexible lines 105 in place at a chosen length to act as the tension to secure the mobile device to the user rather than using the springs of reels 110 as the tension. Clip mechanism 115 or other alternate or additional means for creating this tension may be advantageous in some situations for example, without limitation, when the user would like to protect the strength of the spring-loaded reels or when the attachment mechanism comprises manual reels rather than spring-loaded reels. It is contemplated that some embodiments may comprise a multiplicity of suitable means for creating the tension for holding the mobile device in place including, without limitation, elasticity in the entirety of the lines or a portion of the lines, sliding buckles, adjustable bar buckles, snap release buckles, snaps, ratcheting mechanisms, spring mechanisms, etc. Also, spring mechanisms, weight, pulley systems, friction, soft/flexible material could create tension when attached to flexible lines 105. A human body, animal body or objects itself is flexible, so it can create tension needed when using flexible lines 105. Those skilled in the art will readily recognize, in light of and in accordance with the teachings of the present invention that retractable lines in some embodiments may be implemented in various different configurations and using various different means. For example, without limitation, the reels and lines in some embodiments may be shaped differently, may be placed in different locations in the mechanism, may be provided in different quantities, etc. Moreover, in some embodiments the attachment mechanism may be built into the mobile device so that the lines are retracted back into the mobile device itself, and other embodiments may be incorporated into case designed for housing the mobile devices. For example, attachment mechanism 101 may be incorporated into the case housing of the mobile device. Furthermore, in other embodiments, in an economical way for lines 105 to retract and stored away, the lines 105 loops/rotates against one anchor point[s]/axle[s]. In another embodiment, lines 105 loops/rotates against two anchor points/axles

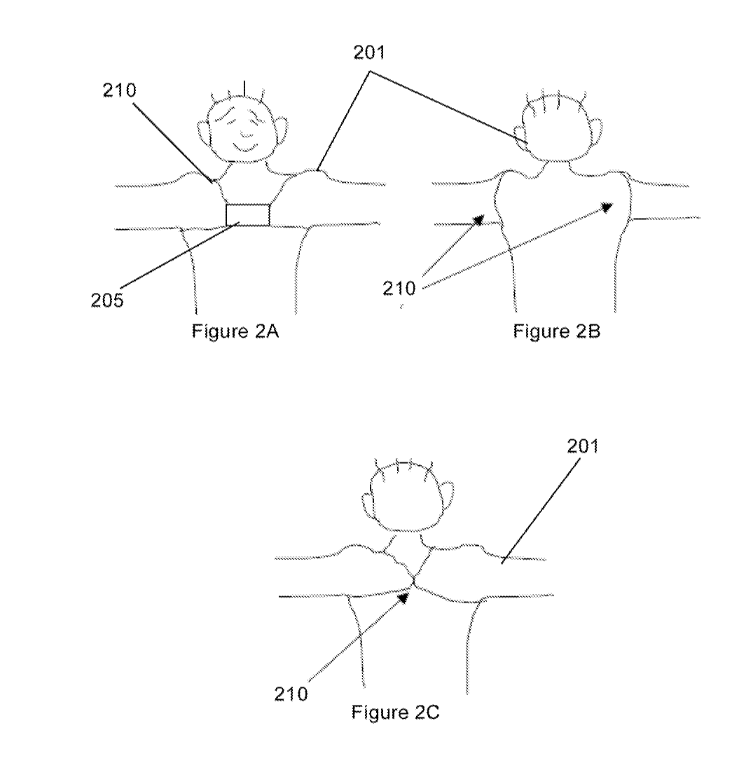

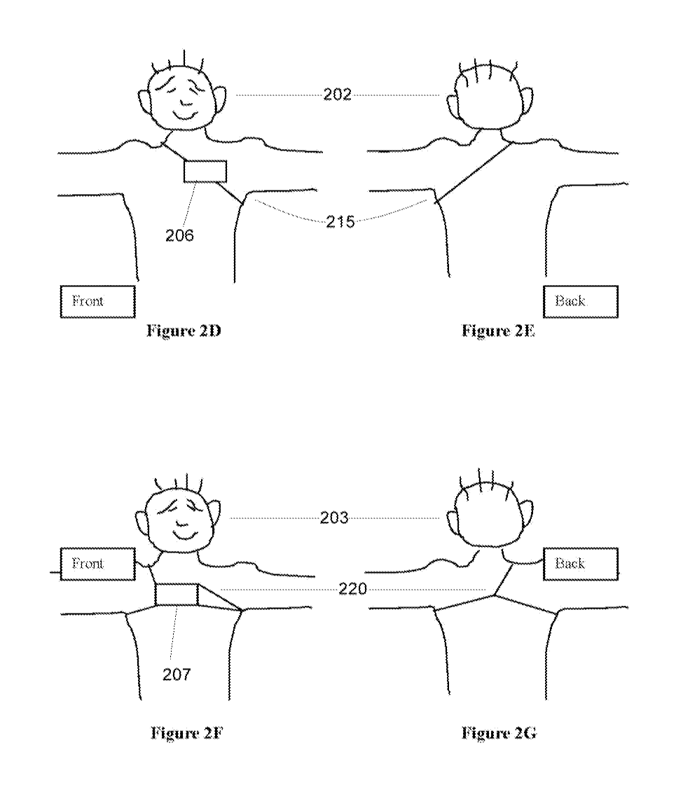

In the present embodiment, a part or the entire line implement 105 may be flexible, elastic, and/or stretchable, and may be made with a multiplicity of suitable materials such as, but not limited to, flat strap, round rope, strap or rope in other shapes, wire, cable, rubber straps or belts, bungee cords, etc. One or both lines 105 may have multiple functions including, but not limited to, measuring tapes, decorative line items having a variety of colors, or both, lines having aesthetic and pleasant appearance, etc. Each line 105 may comprise a fastener 120 such as, but not limited to a latch, a locking clip, a buckle, a slide clasp, etc. Fastener device 120 may enable the length of lines 105 to be adjusted and fixed at the desired positions. Fasteners 120 may also be used to tighten flexible lines 105. In some applications lines 105 may be retracted onto reels 110 to be tightened. It is contemplated that some alternate embodiments may be implemented without fasteners on the lines. These embodiments may comprise no means for adjusting the length of the lines or may comprise different means for adjusting the length of the lines such as, but not limited to, the use of knots, clamping mechanisms, snaps along the lines, hook and loop material/mechanisms, latch mechanisms, ratcheting mechanisms, etc. In the present embodiment, two of the four ends of the two sets of flexible lines 105 are positioned at the top two corners of attachment mechanism 101. The other ends of lines 105 are attached to reels 110 and positioned to exit mechanism 101 at the bottom corners of mechanism 101 by clips 115 so that lines 105 extend from the four corners of attachment mechanism 101. Alternatively, lines 105 may be positioned to exit at the bottom corners of attachment mechanism 101 by various different means such as, but not limited to, guides, pulleys, channels, etc. In some applications in which two sets of flexible lines are used, the flexible lines may cross each other as illustrated by way of example in FIG. 2C or not cross each other as illustrated by way of example in FIG. 2B. In some embodiments the configuration of the attachment points for the lines may vary. For example, without limitation, in an embodiment with a single line, the ends of the line may be positioned to extend from the center points of opposing sides of the attachment device, and in an embodiment comprising more than two lines, the lines may be positioned to extend from the four corners of the device along with multiple other locations on the device. In addition, some alternate embodiments may comprise attachment points that may be changeable so that a user may adjust the configuration of the lines.

Referring to FIG. 1, in the present embodiment, for safety, emergency, comfort, convenience or security reasons, tension point segment 125 may be located on lines 105 that may enable lines 105 to release from a user or object to which the device is attached if lines 105 are pulled beyond a certain force. This may help prevent serious injury if any portion of the attachment mechanism 101 catches something such as, but not limited to, a tree branch or other object as the user is in motion. Tension point segment 125 may comprise a section of line that may break when pulled beyond certain force, a safety clip, a breakaway pin, etc. In the same token, tension point segments 125 may comprise a section of line having a material with a predetermined breaking point that may break when pulled beyond a certain force, thereby, preventing injury. In an alternative embodiment, tension points 125 may comprise a buckle device 130 having male/female buckle parts that substantially changes shape. By changing the shape of the male/female buckle part, buckle 130 will snap/breakaway instantly when pulled beyond a certain force, and lines 105 can be re-used right away by re-inserting the male part to the female part of the buckle. In addition, flexible lines 105 may also comprise buckles 130 that may allow for the immediate release of lines 105, which may enable a user to detach attachment mechanism 101 quickly if needed for safety or other reasons. It is contemplated that some alternate embodiments may be implemented with only one of these features, either tension points or release buckles, and other alternate embodiments may be implemented with no such features. In some embodiments release buckles may be incorporated into the fasteners that may be used to adjust the length of the lines. Yet other alternate embodiments may comprise a variety of other features for safety and comfort including, without limitation, reflective or lighted portions to increase visibility of the user, padded portions on the lines, cushioning where the mechanism typically rests on the body, etc. In other embodiments, the attachment mechanism is made from soft, flexible or hard material for safety or heavy duty reasons.

In general use of the present embodiment, a user may pull out the two sets of flexible lines 105, which are initially rolled up on reels 110 when not in use, to create two loops. The user may then place lines 105 on a portion of his body or another object. For example, without limitation, the user may mount a mobile device on his chest by wearing flexible lines 105 on his shoulders or another portion of his upper body, as illustrated by way of example in FIGS. 2A, 2B, 2C, 2D, 2E, 2F and 2G. The first and second flexible lines 105 may be tightened or loosened independently to generally enable the mobile device to be comfortably and securely fixed to virtually any body part of the user including, without limitation, the chest, an arm, a leg, the head, or other body part. Now the user or the object is wearing attachment mechanism 101 holding the mobile devices and may perform the activities he wishes to record, track, photograph, etc. Because lines 105 may be flexible and elastic, the tension of line 105 typically secures the mobile device to the user even when the body changes shape during activity. In another example, without limitation, the attachment mechanism 101 may be worn with a single line wrapped horizontally around the chest while the other line remain retracted. Or, a single line can be worm from the shoulder to the armpit, while the other line is retracted. Furthermore, since lines 105 may be stretchable, the user may be able to see the screen of the mobile device on their body by pulling the device toward his eyes without detaching the mobile device from attachment mechanism 101 and in many instances without adjusting lines 105. In some embodiments, the attachment mechanism may comprise a swivel apparatus that may enable the mobile device to rotate to sit horizontally or vertically. Also, some embodiments may comprise means for tilting the mobile device forward or backward to aid in viewing the mobile device or to adjust the angle of the mobile device for recording. After use, the user may remove attachment mechanism 101 and retract lines 105 by manually rotating lines 105 around reels 110 or by allowing spring loaded reels 110 to automatically retract lines 105. Then, the user may conveniently place the mobile device along with retracted lines 105 in a pocket or a bag and carry the device around with little worry of lines 105 becoming twisted or tangled with each other or other objects. In some cases, the user may leave lines 105 un-retracted if desired.

Those skilled in the art will readily recognize, in light of and in accordance with the teachings of the present invention, that a multiplicity of suitable alternate or additional features may be included on some embodiments. For example, without limitation, some embodiments may comprise a link from connecting the mobile device to the case of the attachment mechanism, which may help prevent a user from dropping the mobile device even if the mobile device is detached from the case. Other embodiments may comprise features for improving the recording, or other features/functions of the mobile device such as, but not limited to, lights, anti-shake mechanisms, microphones, speakers, wire or wireless data link/transmission such as Bluetooth, USB male/female port for the case/mobile device to connect to/from other devices etc. Some embodiments may comprise hooks or clips that may be used to attach various different accessories including, without limitation, earbuds, chargers, flash drives, memory cards, etc. Yet other embodiments may comprise means for providing battery backup power to the attached mobile device.

FIGS. 2A, 2B, 2C, 2D, 2E, 2F, and 2G illustrate a user 201, 202, 203 wearing an exemplary attachment mechanism 205, 206, 207 in accordance with an embodiment of the present invention. FIG. 2A is a diagrammatic front view. FIG. 2B is a diagrammatic rear view with line implement 210 of mechanism 205 in an uncrossed configuration, and FIG. 2C is a diagrammatic rear view with lines 210 of mechanism 205 in a crossed configuration. In the present embodiment, the two sets of flexible lines 210 may have the option to cross each other or not. Referring to FIG. 2B, to wear attachment mechanism 205 on his chest with lines 210 uncrossed, user 201 may place his left hand to the left loop of lines 210 and his right hand to the right loop of lines 210 until the loops sit on his shoulders. Referring to FIG. 2C, to wear attachment mechanism 205 on his chest with lines 210 crossed, the user may place his left arm in the space between lines 210 on the left side of mechanism 205 and his right arm in the space between lines 210 on the right side of mechanism 205 so that the crossed portion of lines 205 sits near the middle of his back. User 201 may then tighten lines 210 by retracting lines 210 or by adjusting fasteners on lines 210 if fasteners are present. FIG. 2D is a diagrammatic front view of the attachment mechanism 207 in an exemplary single retracting line 215 implementation. For example, without limitation, referring to FIG. 2D, one embodiment may be worn with a single set of line implement 215 from the shoulder to the armpit, while the other line implement 215 is retracted. Or, a single set of line implement 215 may be wrapped horizontally around the chest while the other line implement 215 is retracted. FIG. 2E is a diagrammatic rear view of the mechanism 206 in an exemplary single line 215 implementation. FIG. 2F is a diagrammatic front view of the mechanism 207 in an exemplary dual line 220 implementation with one set of the line 220 implement on the shoulder and the other set of the line implements 220 under the armpit. Referring to FIG. 2G is a diagrammatic rear view the mechanism 208 in an exemplary dual line 220 implementation of FIG. 2F. It is contemplated that some embodiments of the present invention may be worn in a multiplicity of suitable ways since the first and second flexible lines 210, 215, 220 may be retracted or loosened independently, to generally enable the mobile device to be comfortably and securely fixed to virtually any body part of the user 201, 202, 203. For example, during a casual walk, a bike ride, doing chores, etc. Another embodiment may comprise two shoulder straps and one horizontal chest strap. Yet other embodiments may be configured to be worn on an upper arm or leg with one or two straps, to be worn on the head with one strap, to be placed on bicycle handles with two straps, etc. In some embodiments, the attachment mechanism 205, 206, 207 may comprise a swivel apparatus that may enable the mobile device to rotate to sit horizontally or vertically.

It is believed that existing strap designs to convert mobile devices to body cameras are typically large, heavy, inconvenient to carry, and hang loosely, which may cause the straps to become twisted or tangled together and/or caught on other objects or may get in the way of the activity that the mobile device is meant to be recording or tracking. An aspect of some embodiments of the present invention is to provide retractable line implements that may help prevent tangling and/or catching and may keep the lines neatly out of the way of activity and convenient to carry. Another aspect of some embodiments is to provide safety features such as, but not limited to, tension points and release buckles that may typically enable the lines to break away from the user if a line catches an object like a tree branch during use, which may potentially choke or otherwise injure the user. In an alternative embodiment, attachment mechanism may further comprise of a retractable measuring tape device attached to the back of the mechanism so people can conveniently wear their mobile/portable/handheld electronic device hands free and use the measuring tape device functions.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing mechanisms that may be used for securing mobile devices to an individual according to the present invention will be apparent to those skilled in the art. Various aspects of the invention have been described above by way of illustration, and the specific embodiments disclosed are not intended to limit the invention to the particular forms disclosed. The particular implementation of the mechanisms for securing mobile devices to an individual may vary depending upon the particular context or application. By way of example, and not limitation, the mechanisms for securing mobile devices to an individual described in the foregoing were principally directed to implementations for mounting electronic devices; however, similar techniques may instead be applied to means for mounting non-electronic items to an individual or an object such as, but not limited to, money belts, pouches or bags, child carriers, or gun holsters, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
an attachment mechanism comprising;
a line implement, said line implement comprising at least a first retractable line implement and a second retractable line implement, wherein said first and second retractable lines being configured to generally attach at least a mobile device to at least one of an object, a user, and a monitored or tracked subject, and in which said line implement further comprising an elastic line portion being configured to flexibly and stretchably provide requisite tension on said attached mobile device;
a reel device, said reel device comprising at least a first reel device and a second reel device, wherein said first retractable line implement is substantially retracted by rotating around an anchor point of said first reel device, and wherein said second retractable line is substantially retracted by rotating around an anchor point of said second reel device;
a reel winding mechanism, said reel winding mechanism being configured to substantially retract said line implement by at least manually rotating said reel device or automatically rotating said reel device;
a case structure, said case structure is configured to house said reel device and said line implement, and wherein said first and second retractable line implements are configured to, at least one of, independently retract inside said case and independently loosen out of said case, thereby, enabling different attachment configurations of one or both line implement;
a clip mechanism, said clip mechanism being configured to generally adjust the length of said line implement at a predetermined position, and wherein said clip mechanism further being configured to substantially hold said line implement at a predetermined length to provide requisite tension to said line implement and hold said attached mobile device in place; and
a tension point segment, said tension point segment comprising a section of line of said line implement, in which said tension point segment further comprising a predetermined breaking point, and wherein said section of line is configured to generally break apart when pulled with a force beyond said predetermined breaking point, to detach said attachment mechanism, and mainly prevent injury to a user.

2. The device of claim 1, in which said mobile device comprising at least one of a communication device, smart phone, body camera, action camera, health monitoring device, GPS devices, heart rate monitors, wireless speakers, monitoring devices, tracking devices, and handheld electronic devices.

3. The device of claim 2, in which said case structure comprising at least one of, a case of said mobile device and a case structure attached to a case of said mobile device.

4. The device of claim 3, in which a portion of said line implement further comprising at least one of, a measuring tape device, a decorative line implement having a variety of colors, and a measuring tape device with a decorative line implement segment having a variety of colors.

5. The device of claim 3, in which said reel winding mechanism comprising a crank device being configured to manually rotate said reel device to retract said line implement, and in which said crank device comprising a foldable crank device operable to be folded after use to prevent injury to a user.

6. The device of claim 3, in which said reel winding mechanism comprising a spring-loaded reel winding mechanism being operable for automatically rotating said reel device and automatically retracting said line implement, and in which said reel winding mechanism further comprising a button being configured to be pressed down to start said automatic retraction.

7. The device of claim 3, in which said tension point segment further comprising a buckle, and in which said buckle comprising a male and a female component being configured to allow for the immediate release of said attachment mechanism when pulled with said force beyond said predetermined breaking point, and wherein said buckle is further configured to enable a user to detach said attachment mechanism, when needed, for safety or other reasons.

8. The device of claim 6, further comprising a fastener device being configured to enable a length of said line implement to be adjusted and fixed at a predetermined position, in which said reel winding mechanism comprising at least a first and second winding mechanisms for automatically winding said line segment, said clip mechanism comprising at least a first and second clip mechanisms and said tension point segment comprising at least a first and second tension point segments for independently detaching said first and second retractable lines.

9. An attachment mechanism comprising:
a line implement, said line implement comprising at least a retractable line implement, in which said line implement further comprising an elastic portion,
and wherein said line implement being configured to generally attach at least a mobile device to at least one of an object, a user, and a monitored or tracked subject;
a reel device, said reel device being configured to at least retract said line implement;
a reel winding mechanism, wherein said reel winding mechanism being configured to substantially retract said line implement by at least manually rotating said reel device or automatically rotating said reel device;
a case structure, said case structure is configured to house said reel device and said line implement, and in which said case structure comprising at least one of, a case of said mobile device and a case structure attached to a case of said mobile device;
a clip mechanism, said clip mechanism being configured to generally adjust a length of said line implement at a predetermined position, and wherein said clip further being configured to substantially hold said line implement at a predetermined length to provide requisite tension to said line implement and hold said attached mobile device in place; and
a tension point segment, said tension point segment comprising a section of line of said line implement, in which said tension point segment further comprising a predetermined breaking point, and wherein said section of line is configured to generally break apart when pulled with a force beyond said predetermined breaking point, to detach said attachment mechanism, and to mainly prevent injury to a user.

10. The attachment mechanism of claim 9, in which said line implement comprising at least a first retractable line implement and a second retractable line implement, and wherein said first and second retractable line implement being configured to, at least one of, independently retract inside said case and independently loosens out of said case, thereby, enabling different attachment configurations of one or both retractable line implement.

11. The attachment mechanism of claim 10, in which said reel device comprising at least a first reel device and a second reel device, and wherein said first retractable line implement is substantially retracted around said first reel device, and wherein said second retractable line is substantially retracted around said second reel device.

12. The attachment mechanism of claim 11, in which said reel winding mechanism comprising at least a first and second winding mechanisms for automatically winding said line segment, said clip mechanism comprising at least a first and second clip mechanisms, and said tension point segment comprising at least a first and second tension point segments for independently detaching said first and second retractable lines.

13. The attachment mechanism of claim 12, in which said mobile device comprising at least one of a communication device, smart phone, body camera, action camera, health monitoring device, GPS devices, heart rate monitors, wireless speakers, monitoring devices, tracking devices, and handheld electronic devices.

14. The attachment mechanism of claim 9, further comprising a fastener device being configured to enable a length of said line implement to be adjusted and fixed at a predetermined position.

15. The attachment mechanism of claim 9, in which a portion of said line implement further comprising at least one of, a measuring tape device, a decorative line implement having a variety of colors, and a measuring tape device with a decorative line implement segment having a variety of colors.

16. The attachment mechanism of claim 9, in which said reel winding mechanism comprising a crank device being configured to manually turn said reel device to retract said line implement, and wherein said crank device is a foldable crank device being operable to be folded after use to prevent injury to a user.

17. The attachment mechanism of claim 9, in which said reel winding mechanism comprising a spring-loaded reel winding mechanism for automatically rotating said reel device and automatically retracting said line implement, and in which said reel winding mechanism further comprising a button being configured to be pressed down to start said automatic retraction.

18. The device of claim 9, in which said tension point segment further comprising a buckle, and in which said buckle comprising a male and female component being configured to release of said attachment mechanism when pulled with said force beyond said predetermined breaking point, and wherein said buckle is further configured to be detach said attachment mechanism when needed for safety or other reasons.

19. A device comprising:
means for attaching at least a mobile device to at least one of an object, a user, and a monitored or tracked subject;
means for retracting said attaching means;
means for, at least one of, manually rotating said retracting means and automatically rotating said retracting means, to substantially retract said attaching means;
means for housing said retracting means and said attaching means, and in which said housing means comprising at least one of, mobile device housing means and a housing means attached to a mobile device housing means;
means for adjusting a length of said attaching means at a predetermined position, and wherein said adjusting means further being configured to substantially hold said attaching means at a predetermined length to provide requisite tension to said attaching means and hold said attached mounted mobile device in place; and
means for detaching said device, in which said detaching means comprising a predetermined breaking point, and wherein said detaching means is configured to generally break apart when pulled with a force beyond said predetermined breaking point and to mainly prevent injury to a user.

20. The device of claim 19, in which said attaching means comprising at least a first and second attaching means, said retracting means comprising at least a first and second retracting means for automatically winding said line segment, said adjusting means comprising at least a first and second adjusting means and said detaching means comprising at least a first and second detaching means for independently detaching said first and second attaching means.
